(19) United States
(12) Patent Application Publication
(10) Pub. No.: US 2007/0146563 A1
(43) Pub. Date: Jun. 28, 2007

(54) LIQUID CRYSTAL DISPLAY AND METHOD OF MANUFACTURING THEREOF

(76) Inventors: Yong-Kuk YUN, Suwon-si (KR); Baek-Kyun Jeon, Yongin-si (KR); Yong-Hwan Shin, Yongin-si (KR); Duck-Jong Suh, Seoul (JP)

Correspondence Address: F. CHAU & ASSOCIATES, LLC, 130 WOODBURY ROAD, WOODBURY, NY, 11797, US

(21) Appl. No.: 11/610,656

(22) Filed: Dec. 14, 2006

(30) Foreign Application Priority Data
Dec. 14, 2005 (KR) 10-2005-0123134

(51) Int. Cl. G02F 1/133; G02F 1/1337

(52) U.S. Cl. 349/36; 349/123

(57) ABSTRACT

a liquid crystal display includes a pixel having a first region and a second region, wherein the pixel comprises a pixel electrode, a comon electrode facing the pixel electrode, and an alignment layer formed on at least one of the pixel electrode and the common electrode, wherein the alignment layer has different thicknesses in a first region and a second region, and a voltage ratio of the second region to the first region is about 0.1 to 0.95.

### CROSS-REFERENCE TO RELATED APPLICATION

This application claims priority to Korean Patent Application No. 10-2005- 0123134 filed on Dec. 14, 2005, the contents of which are incorporated herein by reference in their entirety.

### BACKGROUND OF THE INVENTION

(a) Technical Field

The present disclosure relates to a liquid crystal display, and more particulary to a liquid crystal display having an alignment layer with different thicknesses.

(b) Discussion of the Related Art

Liquid crystal displays are flat panel displays. Liquid crystal displays include two panels on which field-generating electrodes, such as pixel electrodes and a common electrode, are formed, and a liquid crystal layer disposed between the panels. Liquid crystal displays apply a voltage to the field-generating electrodes to generate an electric field in the liquid crystal layer. With the electric field, orientations of liquid crystal molecules of the liquid crystal layer can be determined, and polarization of input light to display an image can be controlled.

Liquid crystal displays may further include a switching element connected to each pixel electrode, and a plurality of signal lines, such as gate lines or data lines, to apply a voltage to a pixel electrode to control the switching element.

A vertical alignment (VA) mode LCD aligns LC molecules such that the long axes of the LC molecules are perpendicular to the panels in the absence of an electric field. The VA mode LCD has a high contrast ratio and a wide reference viewing angle. The reference viewing angle has been defined as a viewing angle resulting in a contrast ratio equal to 1:10 and/or as a limit angle for the inversion in luminance between grays.

The VA mode liquid crystal displays can achieve a wide viewing angle by forming a cutout in a field-generating electrode or by forming a cutout on a field generating electrode. Based on a cutout, the inclined direction of the liquid crystal molecule may be dispersed in several ways and a reference viewing angle may be widened.

Patterned vertical alignment (PVA) mode liquid crystal displays having cutouts divide one pixel into two subpixels and apply different voltages to the subpixels through different switching elements so that light transmittance is changed and side visibility can be improved.

In the PVA mode liquid displays, contact holes can be formed in two subpixel electrodes included in two subpixels to connect the subpixels to the switching elements. Thus, an aperture ratio can be reduced.

### SUMMARY OF THE INVENTION

According to an embodiment of the present invention, a liquid crystal display includes a pixel including first and second regions, a pixel electrode, a common electrode facing the pixel electrode, and an alignment layer formed on at least one of the pixel electrode and the common electrode. The alignment layer may have different thicknesses in the first region and the second region, and a voltage ratio of the second region to the first region can be about 0.1 to 0.95.

The voltage ratio of the second region to the voltage of the first region may be about 0.5 to 0.9.

A thickness ratio of the alignment layer in the second region to a thickness of the alignment layer in the first region may be about 0.1 to 0.95.

The alignment layer may be an alignment layer.

The inorganic alignment layer may include at least one of amorphous silicon, silicon carbide, silicon nitride, silicon oxide, or fluorinated diamond-like carbon.

An area ratio of the first region to the second region may be about 1:1 to 1:3.

The display may further include a first incline determination member formed on the pixel electrode.

The display may further include a second incline determination member formed on the common electrode.

The first and second incline determination members may include a cutout having a slanting portion.

According to an embodiment of the present invention, a liquid crystal display includes a pixel having first and second regions, a pixel electrode, a common electrode facing the pixel electrode, and an inorganic alignment layer formed on at least one of the pixel electrode and the common electrode. The inorganic alignment layer may have different thicknesses in the first region and the second region.

A thickness ratio of the inorganic alignment layer in the first region to the inorganic alignment layer in the second region may be about 0.1 to 0.95.

According to an embodiment of the present invention, a method for manufacturing a liquid crystal display includes forming a gate line having a gate electrode on a first substrate, depositing a gate insulating layer on the first substrate, forming a semiconductor on the gate insulating layer, forming a data line and a drain electrode on the semiconductor and the gate insulating layer, forming a pixel electrode connected to the drain electrode, and forming an inorganic alignment layer having first and second portions on the pixel electrode, the first and the second portions having different thicknesses from each other.

The method may further include forming a light blocking member on a second substrate, forming a color filter on the second substrate, forming a common electrode on the light blocking member and the color filter, and forming the inorganic alignment layer having the first and second portions having different thicknesses from each other on the common electrode.

A thickness ratio of the second portion to the thickness of the first region may be about 0.1 to 0.95.

The inorganic alignment layer may be formed by depositing an inorganic material by chemical vapor deposition.

The inorganic alignment layer may be formed by depositing an inorganic material having a first thickness on the entire pixel electrode, and depositing the inorganic material having a second thickness on at least one portion of the pixel electrode.

A ratio of a sum of the first and second thicknesses to the first thickness may be about 0.1 to 0.95.

The inorganic alignment layer may be formed by depositing an inorganic material having a first thickness on the entire pixel electrode, and etching a portion having the second thickness from the deposited inorganic material having the first thickness.

A ratio of a difference between the first and second thicknesses to the first thickness may be about 0.1 to 0.95.

The etching may be performed by use of a laser.

The inorganic alignment layer may include at least one of amorphous silicon, silicon carbide, silicon nitride, silicon oxide, and fluorinated diamond-like carbon.

An area ratio of the first portion to the second portion can be about 1:1 to about 1:3.

### BRIEF DESCRIPTION OF THE DRAWINGS

Exemplary embodiments of the present invention can be understood in more detail from the following description taken in conjunction with the accompanying drawings in which:

FIG. 1 is a block diagram of a liquid crystal display according to an exemplary embodiment of the present invention;

FIG. 2 is an equivalent circuit diagram of a pixel of a liquid crystal display according to an exemplary embodiment of the present invention;

FIG. 3 is a layout view of a liquid crystal display according to an exemplary embodiment of the present invention;

FIG. 4 is a layout view of a thin film transistor array panel of a liquid crystal display according to an exemplary embodiment of the present invention;

FIG. 5 is a layout view of a common electrode panel of a liquid crystal display according to an exemplary embodiment of the present invention;

FIG. 6 and FIG. 7 are cross-sectional views of a liquid crystal display taken along the lines VI-VI and VII-VII in FIG. 3, respectively;

FIG. 8 is a cross-sectional view of a liquid crystal display according to an exemplary embodiment of the present invention;

FIG. 9A to FIG. 9G are cross-sectional views for illustrating a method of manufacturing the thin film transistor array panel of FIG. 4, according to an exemplary embodiment of the present invention;

FIG. 10 is a cross-sectional view for illustrating a method of manufacturing the thin film transistor array panel of FIG. 4 according to an exemplary embodiment of the present invention; and

FIG. 11A to FIG. 11F are cross-sectional views for illustrating a method of manufacturing the common electrode panel of FIG. 5, according to an exemplary embodiment of the present invention.

### DETAILED DESCRIPTION OF EXEMPLARY EMBODIMENTS

Exemplary embodiments of the present invention will be described below in more detail with reference to the accompanying drawings. The present invention may be embodied in many different forms and should not be construed as limited to the embodiments set forth herein. It will be understood that when an element such as a layer, film, region, or substrate is referred to as being “on” another element, it can be directly on the other element or intervening elements may also be present.

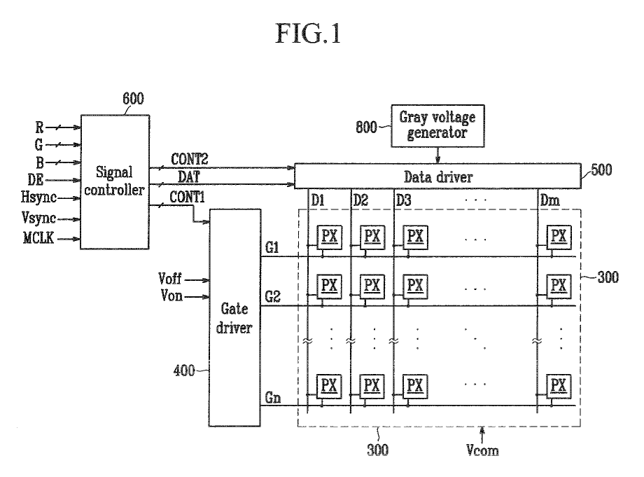

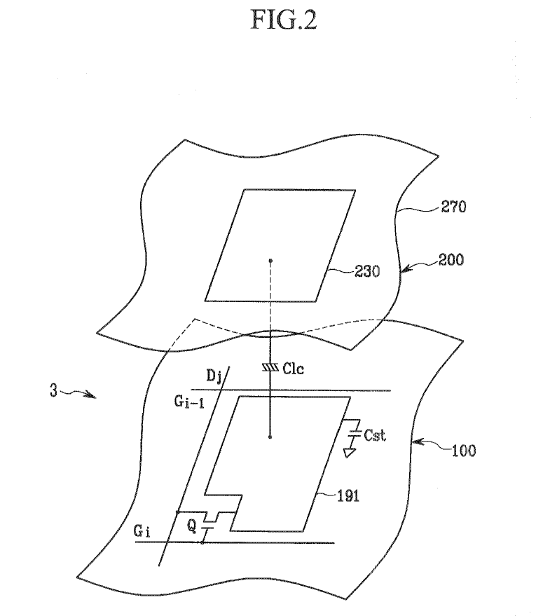

Referring to FIG. 1 and FIG. 2, a liquid crystal display according to an exemplary embodiment of the present invention is illustrated.

FIG. 1 is a block diagram of a liquid crystal display according to an exemplary embodiment of the present invention. FIG. 2 is an equivalent circuit diagram of a pixel of a liquid crystal display according to an exemplary embodiment of the present invention.

Referring to FIG. 1, a liquid crystal display according to an exemplary embodiment of the present invention includes a liquid crystal panel assembly 300, a gate driver 400 and data driver 500 connected to the liquid crystal panel assembly 300, a gray voltage generator 800 connected to the data driver 500, and a signal controller 600 for controlling the liquid crystal panel assembly 300, the gate and data drivers 400 and 500, and the gray voltage generator 800.

Referring to FIGS. 1 and 2, the liquid crystal panel assembly 300 includes a plurality of signal lines G₁-Gₙ and D₁-Dₘ and a plurality of pixels PXs connected to the signal lines and arranged in a matrix. The liquid crystal panel assembly 300 includes a thin film transistor array panel 100 and a common electrode panel 200 facing each other, and a liquid crystal layer 3 disposed therebetween.

The signal lines G₁-Gₙ and D₁- Dₘ include a plurality of gate lines G₁-Gₙ for transferring gate signals (“scanning signals”) and a plurality of data lines D₁-Dₘ for transferring data signals. The gate lines G₁-Gₙ extend in a row direction and are parallel to each other, and the data lines D₁-Dₘ extend in a column direction and are parallel to each other.

Each pixel PX connected to, for example, an i-th (i 1,2, . . . , n) gate line G₁ and a j-th (j 1, 2, . . . , m) data line Dⱼ, has a switching element Q connected to a signal line Gᵢ, Dⱼ. Each pixel PX further includes a liquid crystal capacitor Clc and a storage capacitor Cst connected to the switching element Q. The storage capacitor Cst may be omitted according to an exemplary embodiment of the present invention.

The switching element Q can be a three-terminal element, such as, for example, a thin film transistor disposed on a thin film transistor panel 100. The switching element Q includes a control terminal connected to the gate line Gᵢ, an input terminal connected to the data line Dⱼ, and an output terminal connected to the liquid crystal capacitor Clc and the storage capacitor Cst.

Each liquid crystal capacitor Clc has two terminals, that is, the pixel electrode 191 of the thin film transistor array panel 100 and the common electrode 270 of the common electrode panel 200. The liquid crystal layer 3 disposed between the two electrodes 191 and 270 acts as a dielectric material. The pixel electrode 191 is connected to the switching element Q. The common electrode 270 is formed on the common electrode panel 200 and receives a common voltage Vcom. The common electrode 270 may be formed on the thin film transistor array panel 100, wherein at least one of the electrodes 191 and 270 may have a linear or plate shape.

The storage capacitor Cst acts as an assistant of the liquid crystal capacitor Clc. The storage capacitor Cst can be formed by overlapping an additional signal line (not shown) formed on the thin film transistor panel 100 and the pixel electrode 191 with an insulator therebetween. A predetermined voltage, such as a common voltage Vcom, is applied to the additional signal line. In an exemplary embodiment of the present invention, the storage capacitors Cst may be formed by overlapping the pixel electrode 191 and a previous gate line with an insulator therebetween.

Each pixel PX may represent one of primary colors (a spatial division), or each pixel PX may represent the primary colors by a period of time (a temporal division). A color can be represented by a spatial and temporal sum of the primary colors. The primary colors include red, green, and blue. FIG. 2 shows an exemplary spatial division. In FIG. 2, each pixel PX has a color filter 230 representing one of the primary colors on an area of the common electrode panel 200 corresponding to the pixel electrode 191. In an exemplary embodiment of the present invention, the color filter 230 may be formed on or under the pixel electrode 191 of the thin film transistor panel 100.

The liquid crystal panel assembly 300 may have at least one polarizer (not shown) that polarizes light and can be attached on the outside of the liquid crystal panel assembly 300.

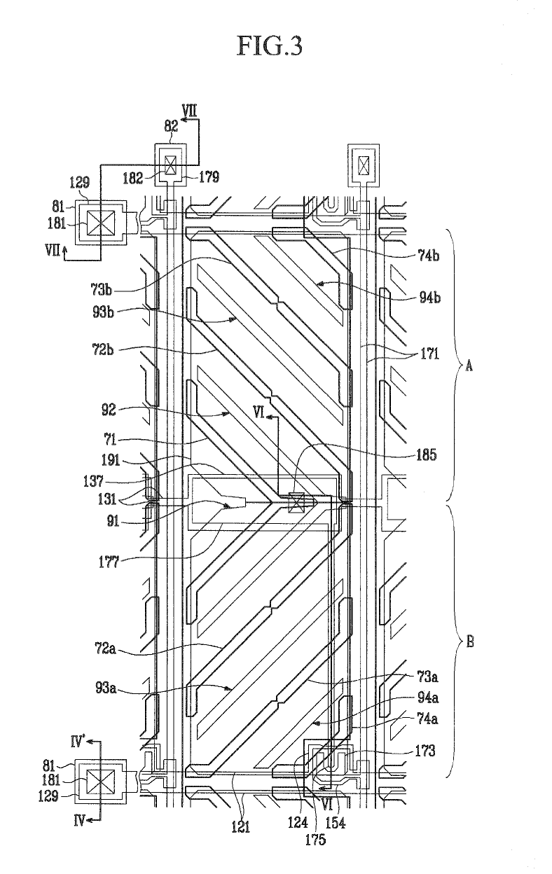

Referring to FIG. 3 to FIG. 7, a liquid crystal panel assembly according to an exemplary embodiment of the present invention is illustrated.

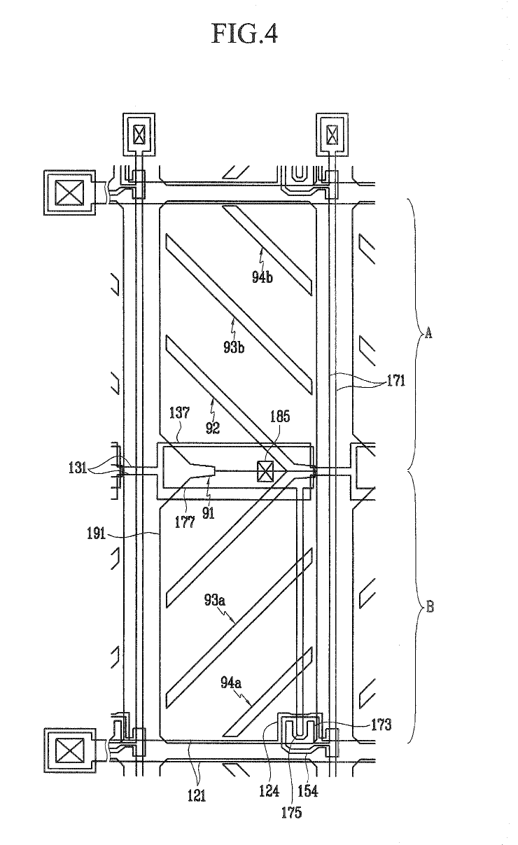

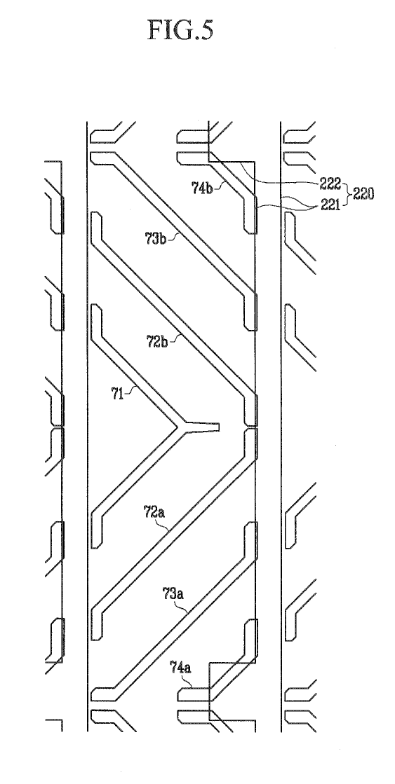

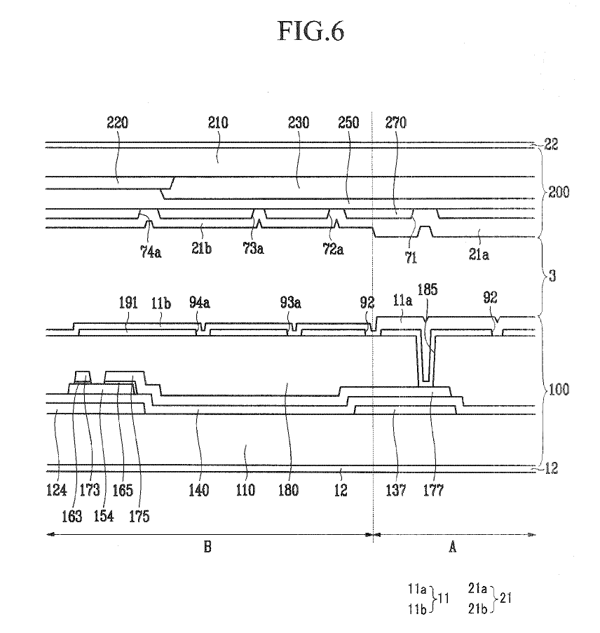

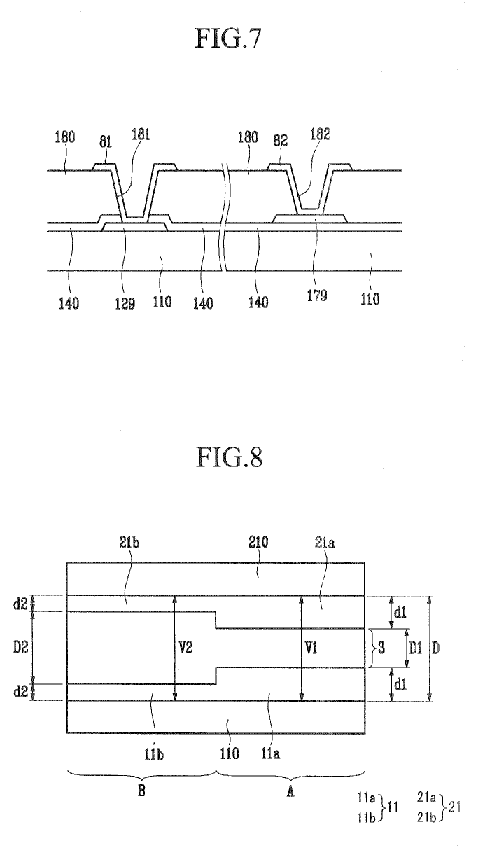

FIG. 3 is a layout view of a liquid crystal display according to an exemplary embodiment of the present invention. FIG. 4 is a layout view of a thin film transistor array panel of the liquid crystal display according to an exemplary embodiment of the present invention. FIG. 5 is a layout view of a common electrode panel of the liquid crystal display according to an exemplary embodiment of the present invention. FIG. 6 and FIG. 7 are cross-sectional views of the liquid crystal display, taken along the lines - and - of FIG. 3, respectively.

Referring to FIG. 3 to FIG. 7, a liquid crystal display according to an exemplary embodiment of the present invention includes a thin film transistor array panel 100 and common electrode panel 200 facing each other, and a liquid crystal layer 3 disposed between the panels 100 and 200.

Referring to FIG. 1, FIG. 2, FIG. 6, and FIG. 7, a thin film transistor array panel 100 is illustrated.

A plurality of gate lines 121 and a plurality of storage electrode lines 131 are formed on an insulation substrate 110 comprising, for example, transparent glass or plastic.

Each gate line 121 transfers a gate signal and extends in a transverse direction. Each gate line 121 has an enlarged end portion 129 for contacting a plurality of gate electrodes 124 protruding upwardly, another layer, or an external driving circuit. A gate driving circuit (not shown) for generating a gate signal may be mounted on a flexible printed circuit film (not shown) attached on the substrate 110, may be directly mounted on the substrate 110, or may be integrated in the substrate 110. When the gate driving circuit is directly integrated in the substrate 110, the gate line 121 may extend and connect to the gate driving circuit directly.

Each storage electrode line 131 receives a predetermined voltage and is parallel to the gate lines 121. Each storage electrode line 131 is disposed between two adjacent gate lines 121, and the distances between the storage electrode line 131 and each of gate lines 121 are substantially identical. The storage electrode line 131 includes a storage electrode 137 expanded upwardly and downwardly. The storage electrode line 131 may have different shapes and arrangements according to exemplary embodiments of the present invention.

The gate line 121 and the storage electrode line 131 may comprise, for example, an aluminum-group metal such as aluminum (Al) or an aluminum alloy, a silver-group metal such as silver (Ag) or a silver alloy, a copper-group metal such as copper (Cu) or a copper alloy, a molybdenum-group metal such as molybdenum (Mo) or a molybdenum alloy, chromium (Cr), tantalum (Ta), and titanium (Ti). In an exemplary embodiment, the gate line 121 and the storage electrode line 131 may have a multilayered structure comprising two conductive layers (not shown) of which physical properties are different from each other. One conductive layer may comprise a low resistivity metal to reduce signal delay or voltage drop, such as, for example, an aluminum-group metal, a silver-group metal, or a copper-group metal. The other conductive layer may comprise a material having good physical, chemical, or electrical contact characteristics with respect to another material, such as, for example, indium tin oxide (ITO) or indium zinc oxide (IZO). The material may include, for example, a molybdenum-group metal, chromium, tantalum, and titanium. As exemplary combinations of the two conductive layers, there is a combination of a chromium lower layer and an aluminum (alloy) upper layer, and a combination of an aluminum (alloy) lower layer and a molybdenum (alloy) upper layer.

The lateral sides of the gate lines 121 and storage electrode lines 131 are inclined with respect to the surface of the substrate 110, and the inclined angle may be about 30 to about 80°.

A gate insulating layer 140, comprising, for example silicon nitride (SiNx) or silicon oxide (SiOx), is formed on the gate lines 121 and the storage electrode lines 131.

A plurality of semiconductor islands 154, comprising, for example, hydrogenated amorphous silicon or polysilicon, are formed on the gate insulating layer 140. A semiconductor island 154 is disposed on a gate electrode 124 and has an extension portion covering a portion, for example, a border, of the gate line 121. A plurality of ohmic contact island members 163 and 165 are formed on the semiconductor island 154. The ohmic contact island members 163 and 165 may comprise materials such as n+ hydrogenated amorphous silicon on which an n-type impurity such as phosphorus is doped in a high concentration, or silicide. The ohmic contact island members 163 and 165 form a pair and are disposed on the semiconductor island 154.

The lateral sides of the semiconductor island 154 and ohmic contact island members 163 and 165 are inclined with respect to the surface of the substrate 110, and the inclined angle is about 30° to about 80°.

A plurality of data lines 171 and a plurality of drain electrodes 175 are formed on the ohmic contact island members 163 and 165 and the gate insulating layer 140.

Each data line 171 transfers a data voltage and extends in a vertical direction, while intersecting the gate lines 121 and the storage electrode lines 131. Each data line 171 has an enlarged end portion 179 for contacting a plurality of source electrodes 173 extending toward the gate electrode 124, another layer, or an external driving circuit. A data driving circuit (not shown) for generating a data voltage may be disposed on a flexible printed circuit film (not shown) attached on the substrate 110, may be directly disposed on the substrate, or may be integrated in the substrate 110. When the data driving circuit is directly integrated in the substrate 110, the data line 171 may extend and connect to the data driving circuit.

The drain electrode 175 is separated from the data line 171, and faces the source electrode 173 with the gate electrode 124 therebetween. Each drain electrode 175 has one enlarged end portion 177. The other end portion of the drain electrode 175 has, for example, a plate shape. The enlarged end portion 177 overlaps the storage electrode 137. The plate-shaped end portion is partially surrounded by a U-shaped curved source electrode 173.

One gate electrode 124, one source electrode 173, and one drain electrode 175, along with semiconductor islands 154, form one thin film transistor (TFT). The thin film transistor has a channel formed on the semiconductor islands 154 between the source electrode 173 and the drain electrode 175.

The data line 171 and the drain electrode 175 may comprise a refractory metal, such as, for example, molybdenum, chromium, tantalum, and titanium, or alloys thereof. The data line 171 and the drain electrode 175 may have a multilayered structure having a refractory metal layer (not shown) and a low resistance conductive layer (not shown). As exemplary multilayered structures, there is a dual layer having a chromium or molybdenum (alloy) lower layer and an aluminum (alloy) upper layer, and a triple layer having a molybdenum (alloy) lower layer, an aluminum (alloy) middle layer, and a molybdenum (alloy) upper layer.

The lateral sides of the data lines 171 and drain electrodes 175 may be inclined with respect to the surface of the substrate 110, and the inclined angle may be about 30° to about 80°.

The ohmic contact members 163 and 165 are disposed between the semiconductor island 154 disposed under the ohmic contact members 163 and 165 and the data line 171 and drain electrodes 175 disposed over the ohmic contact members 163 and 165. The ohmic contact members 163 and 165 reduce contact resistance between the semiconcutor island 154, and the data line 171 and drain electrodes 175. The extension portion of the semiconductor island 154 disposed on the gate line 121 causes the surface of the gate line 121 smooth and prevents a short circuit of the data line 171. The semiconductor island 154 has exposed portions, for example, an exposed portion between the source electrode 173 and the drain electrode 175 or an exposed portion that is not covered by the data line 171 and the drain electrode 175.

A passivation layer 180 is formed on the data line 171, the drain electrode 175, and the exposed portion of the semiconductor island 154. The passivation layer 180 may comprise an inorganic insulating material or an organic insulating material, and may have an even surface. The inorganic insulating material may include, for example, silicon nitride or silicon oxide. The organic insulating material may have photosensitivity. The dielectric constant of the organic insulator may be, for example, about 4.0 or less. In an exemplary embodiment, the passivation layer 180 may have a dual-layered structure having a lower inorganic layer and an upper organic layer to maintain a good insulating characteristic of an organic layer, and to prevent the exposed semiconductor island 154 from being damaged.

A plurality of contact holes 182 and 185 for exposing the end portion 179 of the data line 171 and the drain electrode 175, respectively, are formed on the passivation layer 180. A plurality of contact holes 181 for exposing the end portion 129 of the gate line 121 are formed on the passivation layer 180 and the gate insulating layer 140.

A plurality of pixel electrodes 191 and a plurality of contact assisting members 81 and 82 are formed on the passivation layer 130. The pixel electrodes 191 and the contact assisting members 81 and 82 may comprise a transparent conductive material such as, for example, ITO or IZO, or a reflective material such as, for example, aluminum, silver, or alloys thereof.

A pixel electrode 191 is physically and electrically connected to the drain electrode 175 through the contact hole 185, and receives a data voltage from the drain electrode 175. The pixel electrode 191 to which the data voltage is applied, along with the common electrode 270 of the common electrode panel 200 to which a common voltage is applied, form an electric field, thereby determining the direction of the liquid crystal molecules of the liquid crystal layer 3 disposed between two electrodes 191 and 270. According to the determined direction of the liquid crystal molecules, the polarization of the light passing through the liquid crystal layer 3 is changed. A pixel electrode 191 and the common electrode 270 form a capacitor (hereinafter “liquid crystal capacitor”) that maintains the applied voltage even after a thin film transistor is turned off.

The pixel electrode 191 overlaps the storage electrode line 131 and the storage electrode 137. The pixel electrode 191 and the drain electrode 175 connected to the pixel electrode 191 electrically overlap the storage electrode line 131, thereby forming a storage capacitor. The storage capacitor enhances the voltage storage of the liquid crystal capacitor.

Each pixel electrode 191 can have a quadrangle shape having four chamfered edges. A chamfered oblique side is inclined with respect to the gate line 121 by an angle of about 45°.

The pixel electrode 191 has first and second central cutouts 91 and 92, lower cutouts 93a and 94a, and upper cutouts 93b and 94b, and is partitioned into a plurality of regions by the cutouts 91 to 94b. The cutouts 91-94b are symmetrical with respect to the storage electrode line 131.

The lower and upper cutouts 93a-94b substantially slant and extend from the left side of the pixel electrode 191 toward the right side, upper side, or lower side of the pixel electrode 191. The lower and upper cutouts 93a94b are disposed below and above with respect to the storage electrode lines 131. The lower and upper cutouts 93a-94b are inclined with respect to the gate lines 121, for example, by an angle of about 45°, and vertically extend.

The first central cutout 91 extends along the storage electrode line 131 and has an entrance on the left side thereof. The entrance of the first central cutout 91 has a pair of oblique sides each substantially parallel to the lower cutouts 93a and 94a and the upper cutouts 93b and 94b. The second central cutout 92 has a central horizontal portion and a pair of slanting portions. The central horizontal portion of the second center cutout 92 extends from the right side of the pixel electrode 191 to the left side of the pixel electrode 191, along the storage electrode line 131. The pair of slanting portions extend from the end of the central horizontal portion toward the left side of the pixel electrode, while being parallel to the lower and upper cutouts 93a-94b, respectively.

Thus, the lower portion of the pixel electrode 191 is partitioned into four regions by the second central cutout 92 and the lower cutouts 93a and 94a, and the upper portion of the pixel electrode 191 is partitioned into four regions by the second central cutout 92 and the upper cutouts 93b and 94b. The number of partitioned regions or the number of cutouts may depend on design on design factors, such as, for example, the size of the pixel, a length ratio of the horizontal side and vertical side of the pixel electrode, or the type or characteristics of the liquid crystal layer 3.

The contact assisting members 81 and 82 are connected to the end portions 129 of the gate lines 121 and the end portions 179 of the data lines 171 through the contact holes 181 and 182, respectively. The contact assisting members 81 and 82 enhance and protect the connection between the end portions 179 and 129 of the data line 171 and gate line 121 and an external device.

Referring to FIG. 3, FIG. 5, FIG. 6, and FIG. 7, a common electrode panel 200 is illustrated.

A light blocking member 220 is formed on an insulation substrate 210 comprising, for example, transparent glass or plastic. In an exemplary embodiment, the light blocking member 220 is a black matrix, and prevents light leakage. The light blocking member 220 has a linear portion 221 corresponding to the data line 171 and a surface portion 222 corresponding to a thin film transistor. The light blocking member 220 prevents light leakage between the pixel electrodes 191, and defines an opening facing the pixel electrodes 191. In an exemplary embodiment, the light blocking member 220 may have a plurality of openings (not shown) facing the pixel electrode 191 and having a shape substantially identical to that of the pixel electrode 191.

A plurality of color filters 230 are formed on the substrate 210. The color filters 230 can be located in a region surrounded by the light blocking member 220, and extend in a vertical direction along a column of the pixel electrodes 191. Each color filter 230 may represent one of three primary colors, such as red, green, and blue.

An overcoat 250 is formed on the color filters 230 and the light blocking member 220. The overcoat 250 may comprise an organic insulating material. The overcoat 250 may prevent the color filters 230 from being exposed. The overcoat 250 can provide an even surface. The overcoat 250 may be omitted according to an exemplary embodiment of the present invention.

The common electrode 270 is formed on the overcoat 250. The common electrode 270 comprises a transparent conductor such as, for example, ITO or IZO.

A plurality of cutout sets 71, 72a, 72b, 73a, 73b, 74a, and 74b are formed on the common electrode 270.

One set of cutouts 71-74b faces one pixel electrode 191 and has a central cutout 71, lower cutouts 72a, 73a, and 74a, and upper cutouts 72b, 73b, and 74b. Each of the cutouts 71-74b is disposed between adjacent cutouts 91-94b of the pixel electrode 191 or between the cutouts 91-94b and the chamfered oblique side of the pixel electrode 191. Each of the cutouts 71-74b has at least one slanting branch extending in parallel to the lower cutouts 93a and 94a or upper cutouts 93b and 94b of the pixel electrode 191.

Each of the lower and upper cutouts 72a-74b has a slanting branch, a horizontal branch, and a vertical branch. The slanting branch extends substantially parallel to the lower cutouts 93a and 94a or upper cutouts 93b and 94b of the pixel electrode 191, from the right side of the pixel electrode 191 to the left, upper, or lower side of the pixel electrode 191. The horizontal branch and the vertical branch overlap and extend from the end of the slanting branch, along the sides of the pixel electrode 191, and form an obtuse angle with respect to the slant angle.

The central cutout 71 has a central horizontal branch, a pair of slanting branches, and a pair of end vertical branches. The central horizontal branch extends from the right side of the pixel electrode to the left side of the pixel electrode 191, along the horizontal central line of the pixel electrode 191. A pair of slanting branch extends toward the left side of the pixel electrode 191 from the end of the central horizontal branch, while extending substantially parallel to the lower and upper cutouts 72a and 72b. The end vertical branches overlap and extend from the each end of the slanting branches, along the left side of the pixel electrode 191, and form an obtuse angle with respect to the slanting branches.

The branches of the central cutout 71 are converged and form a crossing portion. The crossing portion is located inside the pixel electrode 191 and is wider than the branches.

The number or direction of the cutouts 71-74b depends on design factors.

Alignment layers 11 and 21 are formed on the panels 100 and 200, respectively. In an exemplary embodiment, the alignment layers 11 and 21 can be formed between the panels 100 and 200. The alignment layers 11 and 21 may be vertical alignment layers. The alignment layers 11 and 21 may be inorganic alignment layers. The inorganic alignment layers 11 and 21 may comprise at least one of amorphous silicon (a-Si), silicon carbide (SiC), silicon nitride (SiN), silicon oxide (SiOx), or fluourinated diamond-like carbon.

Referring to FIG. 6, the alignment layers 11 (11a, 11b) and 21 (21a, 21b) have portions with different thicknesses. The liquid crystal panel assembly 300 has a first region A and a second region B. The alignment layers 11a and 21a are formed on the first region A, and alignment layers 11b and 21b are formed on the second region B. The alignment layers 11a and 21a in the first region A are thicker than the alignment layers 11b and 21b in the second region B. A thickness ratio of the alignment layers 11b and 21b of the second region B to the thickness of the alignment layers 11a and 21a of the first region A is, for example, 0.1 to 0.95. Thus, a voltage difference between the two region A and B is formed, thereby side visibility can be improved.

Polarizers 12 and 22 can be formed on the panels 100 and 200, respectively. In an exemplary embodiment, the polarizers 12 and 22 can be formed on outer surfaces on the polarizers 12 and 22. The polarization axis of two polarizers 12 and 22 are perpendicular to each other, and one axis may be parallel to the gate lines 121. When a liquid crystal display is a reflective liquid crystal display, one of the polarizers 12 and 22 may be omitted.

A liquid crystal display may include a backlight unit (not shown) for providing the polarizers 12 and 22, the panels 100 and 200, and the liquid crystal layer 3 with light.

The liquid crystal layer 3 can have negative dielectric anisotropy. The liquid crystal molecules of the liquid crystal layer 3 are arranged such that a longitudinal axis of the liquid crystal molecules is perpendicular to the surfaces of the two panels 100 and 200 when an electric field does not exist. Thus, input light does not pass through crossed polarizers 12 and 22 and is blocked.

A common voltage is applied to the common electrode 270, and a data voltage is applied to the pixel electrodes 191, thereby forming an electric field substantially perpendicular to the surfaces of the panels 100 and 200. The liquid crystal molecules change their directions such that the longitudinal axes of the liquid crystal molecules are perpendicular to the direction of the electric field, in response to the electric field. The pixel electrodes 191 and the common electrode 271 may be referred to as field generating electrodes.

The cutouts 91-94b of the pixel electrodes 191 of the field generating electrodes, the cutouts 71-74b of the common electrode 270 of the field generating electrodes, and an oblique side of a pixel electrode 191 parallel to the cutouts 91-94b and 71-74b distort the electric field and form a horizontal element that determines an inclined direction of the liquid crystal molecules. The horizontal element of the electric field is perpendicular to the oblique sides of the cutouts 91-94b and 71-74b and the oblique side of the pixel electrode 191.

A set of the common electrode cutouts 71-74b and a set of pixel electrode cutouts 91-94b divide each pixel electrode 191 into sub-regions. Each sub-region has two major edges forming an oblique angle with respect to the major edges of the pixel electrode 191. The liquid crystal molecules disposed on each sub-region are perpendicularly inclined with respect to the major edges, and thus there are four inclined directions. Therefore, the viewing angle of the liquid crystal display can be widened by varying the inclined directions of the liquid crystal molecules.

The set of the common electrode cutouts 71-74b and the set of the pixel electrode cutouts 91-94b may be replaced with protruding portions (not shown) or depressed portions (not shown) according to exemplary embodiments of the present invention.

The shapes or arrangement of the set of the common electrode cutouts 71-74b and the set of the pixel electrode cutouts 91-94b may be changes according to exemplary embodiments of the present invention.

Referring to FIG. 1, the gray voltage generator 800 generates a full number of gray voltages or a limited number of gray voltages (referred to as “reference gray voltages”) related to the transmittance of the pixels PX. Some of the reference gray voltages have a positive polarity relative to the common voltage Vcom, while some of the reference gray voltages have a negative polarity relative to the common voltage Vcom.

The gate driver 400 is connected to the gate lines G₁-Gₙ of the liquid crystal panel assembly 300 and applies gate signals, comprising a gate-on voltage Von and a gate-off voltage Voff, to the gate lines G₁-Gₙ.

The data driver 500 is connected to the data lines D₁-Dₘ of the liquid crystal panel assembly 300. The data driver 500 selects a gray voltage from the gray voltage generator 800 and applies the selected gray voltage as a data signal to the data lines D₁-Dₘ. When the gray voltage generator 800 provides a predetermined number of the reference gray voltages, rather than all gray voltages, the data driver 500 divides the reference gray voltages, generates gray voltages for all grays, and selects a data signal among the generated gray voltages.

The signal controller 600 controls the gate driver 400 and the data driver 500.

Each of the driving apparatuses 400, 500, 600, and 800 may be directly disposed on the liquid crystal panel assembly 300, as at least one IC chip. Each driving apparatus may be disposed on a flexible printed circuit film (not shown), and as a tape carrier package (TCP), attached to the liquid crystal panel assembly 300 or to a printed circuit board (PCB) (not shown). In an exemplary embodiment, the driving apparatuses 400, 500, 600 and 800, along with the signal lines G₁-Gₙ and D₁-Dₘ and a thin film transistor switching element Q, may be integrated in the liquid crystal panel assembly 300. In an exemplary embodiment, the driving apparatuses 400, 500, 600, and 800 may be integrated as a single chip, in which at least one circuit forming the driving apparatuses 400, 500, 600 and 800 may be located outside the single chip.

Referring to FIGS. 1, 2 and 8, the signal controller 600 receives input image signals R, G, and B and an input control signal for controlling the representation of the image signals R, G, and B from an external graphics controller (not shown). The input image signals R, G, and B have luminance information of each pixel PX. The luminance information has a predetermined number of grays, for example, 1024 (2¹⁰), 256 (2⁸), or 64 (2⁶). The input control signal has, for example, a vertical synchronization signal Vsync, a horizontal synchronizing signal Hsync, a main clock signal MCLK, or a data enable signal DE.

The signal controller 600 processes the input image signals R, G, and B based on the input control signal. The input image signals R, G, and B, according to the operating conditions of the liquid crystal panel assembly 300 and data driver 500, generates a gate control signal CONT1 and a data control signal CONT2. The gate control signal CONT1 is applied to the gate driver 400. The data control signal CONT2 and processed image signal DAT are applied to the data driver 500. The output image signal DAT can be a digital signal and can have a predetermined number of values (grays).

The gate control signal CONT1 includes a scanning start signal STV for indicating a scanning start and at least one clock signal for controlling an output period of a gate-on voltage Von. The gate control signal CONT1 may further include an output enable signal OE for limiting a lasting time of the gate-on voltage Von.

The data control signal CONT2 includes a horizontal synchronization start signal STH for indicating a transfer starting of image data with respect to a pixel column, a load signal LOAD for applying a data signal to the liquid crystal panel assembly 300, and a data clock signal HCLK. The data control signal CONT2 may further include an inversion signal RVS for inverting the voltage polarity of a data signal with respect to a common voltage Vcom (hereinafter, the voltage polarity of the data signal with respect to the common voltage is abbreviated as “a polarity of a data signal”).

In response to the data control signal CONT2 of the signal controller 600, the data driver 500 receives a digital image signal DAT corresponding to a pixel column, selects a gray voltage corresponding to each digital image signal DAT, converts the digital image signal DAT into an analog data signal, and applies the analog data signal to a corresponding data line.

The gate driver 400 applies the gate-on voltage Von to a gate line in response to the gate control signal CONT1 of the signal controller 600, and turns on the switching element connected to the gate line. Then, the data signal applied to the data line is applied to a corresponding pixel through a turned on switching element.

The difference between the voltage of the data signal applied to the pixel PX and a common voltage Vcom is represented as a charge voltage of a liquid crystal capacitor Clc, that is, a pixel voltage. The arrangement of liquid crystal molecules changes in response to the size of the pixel voltage, and thus the polarization of the light passing through the liquid crystal layer 3 is changed. The polarization change is represented as transmittance change through a polarizer attached to the panel assembly 300.

The above process can be repeated by a unit of 1 horizontal period (“1H”) that is identical to one period of the horizontal synchronizing signal Hsync and the data enable signal DE. Thus, a gate-on voltage Von is applied to all of the gate lines G₁-Gₙ and all pixels PXs receive data signals to display an image of a frame.

After one frame is completed, a subsequent frame starts. The inversion signal RVS to be applied to the data driver 500 is controlled such that the data signal applied to each pixel PX has an opposite polarity to the polarity of the data signal applied to the pixel of a previous frame (“frame inversion”). Within one frame, the polarity of the data signal passing along a data line may be changed according to the characteristic of the inversion signal RVS (for example, row inversion or dot inversion), or the data signals applied to a pixel column may have different polarities (for example, column inversion or dot inversion).

Referring to FIG. 8, a voltage difference for each region of a liquid crystal display according to an exemplary embodiment of the present invention is illustrated.

FIG. 8 is a cross-sectional view of a liquid crystal panel assembly according to an exemplary embodiment of the present invention.

Referring to FIG. 8, the liquid crystal panel assembly has first and second regions A and B. The alignment layers 11 and 21 have different thicknesses in the first and second regions A and B. The voltage differences between the pixel electrodes 191 and the common electrode 270 are different in the regions A and B.

The electric charge Q1 of the first region A and the electric charge Q2 of the second region B may be represented as in the following Equations 1 and 2.

(Equation 1)
Q1=C1×V1

(Equation 2)
Q2=C2×V2

C1 and C2 are electrical capacities of the first and second regions A and B, respectively, and V1 and V2 are potential voltages between the field generating electrodes 194 and 270 within the first and second regions A and B.

Since the electric charges of the first and second regions a and B are the same, Q1 and Q2 are the same. Thus, Equations 1 and 2 may be represented as in the following Equation 3. Equation 3 may be represented as in the following Equation 4.

(Equation 3)
C1×V1=C2×V2

(Equation 4)
V1/V2=C2/C1

The electrical capacity C is represented as in the following Equation 5.

(Equation 5)
C=εₒε(A/d)

Here, ε is permittivity, εₒ is permittivity of vacuum, that is 8.855×10⁻¹²F/m, A is an area, and d is a thickness.

When, in a liquid crystal display of 40 inches (width: length=16:9), an area ratio of the first and second regions A and B is, for example, 1:1, a potential difference between the field generating electrodes 191 and 270 in the first and second regions A and B is calculated as follows.

Each of the electrical capacities C1 and C2 of the first and second regions A and B is a sum of the electrical capacity of the liquid crystal layer 3 and the electrical capacity of the alignment layers 11, 21. Each of the electrical capacities C1 and C2 of the first and second regions A and B may be represented as in each of the following Equations 6 and 7.

(Equation 6)
C1=[ε_{O}ε_{1c}×(0.7×10⁵μm²/D2)]×2×[ε_{O}εₐₗᵢ×(0.7×10⁵μm²/d2]

(Equation 7)
C2=[ε_{O}ε_{1c}×(0.7×10⁵μm²/D1]×2×[ε_{O}εₐₗᵢ×(0.7×10⁵μm²/d2 ]

Here, ε_{1c} is the permittivity of the liquid crystal layer 3, εₐₗᵢ is the permittivity of the alignment layer 11, 21, d1 and d2 are the thicknesses of the alignment layers 11, 21 in the first and second regions A and B, respectively, and D1 and D2 are the thicknesses of the liquid crystal layers 3 in the first and second regions A and B. In an exemplary embodiment, ε_{1c} is 3.6 and εₐₗᵢ is 3.9 when the alignment layer is an inorganic alignment layer comprising silicon oxide (SiO₂).

The ratio V1/V2 of the potential differences V1 and V2 between the pixel electrode 191 and the common electrode 270 in each of the first and second regions A and B, as shown in Equation 4, may be represented as in the following Equation 8. The area of a pixel is 1.4×10⁵μm², and the distance between the pixel electrode 191 and the common electrode 270 is 3.8 μm.

(Equation 8)
V1/V2={[ε_{O}ε_{1c}×(0.7×10⁵μm²/D1]×2×[ε_{O}εₐₗᵢ×(0.7×10⁵μm²/d2]{/}[ε_{O}ε_{1c}×(0.7×10⁵μm²/D2)]×2×[ε_{O}εₐₗᵢ×(0.7×10⁵μm²/d2]}

When d1 is 1000 Å and d2 is 500 Å, D1 is 3.9 μm and D2 is 3.8 μm.

Thus, V1/V2 is 0.51.

Alternatively, when d1 is 1000 Å and d2 is 700 Å, D1 is 3.8 μm and D2 is 3.86 μm.

Thus, V1/V2 is 0.71.

Accordingly, a voltage ratio of the first and second regions A and B is controlled by controlling the thicknesses of the alignment layers 11 and 21 in the first and second regions A and B. The inclined angles of the liquid crystal molecules depend on the strength of the electric field. Since the voltages of the two regions A and B are different from each other, the inclined angles of the liquid crystal molecules are different and luminances of the two regions are different. Thus, if the voltage of the first region A and the voltage of the second region B are properly controlled, the image at a side surface is substantially identical to the image at the front. That is, a side gamma curve is substantially identical to a front gamma curve, and side visibility is improved.

The voltage ratio of the second region B to the voltage of the first region A is, for example, about 0.1 to 0.95, or about 0.5 to 0.9.

In an area where the thicknesses of the alignment layers 11 and 21 are greater, the voltage difference between the field generating electrodes 191 and 270 is greater. The thickness ratio of the alignment layers 11 and 21 in the second region B to the alignment layers 11 and 21 in the first region A is, for example, about 0.1 to 0.95.

The area ratio of the second region B to the area of the first region A is, for example, about 1 to 3. When the area of the first region A that generates a higher potential difference is smaller than the area of the second region B, the side gamma curve is closer to the front gamma curve. When the area ratio of the first and second regions A and B is about 1:2 to about 1:3, the side gamma curve is closer to the front gamma curve and side visibility can be further improved.

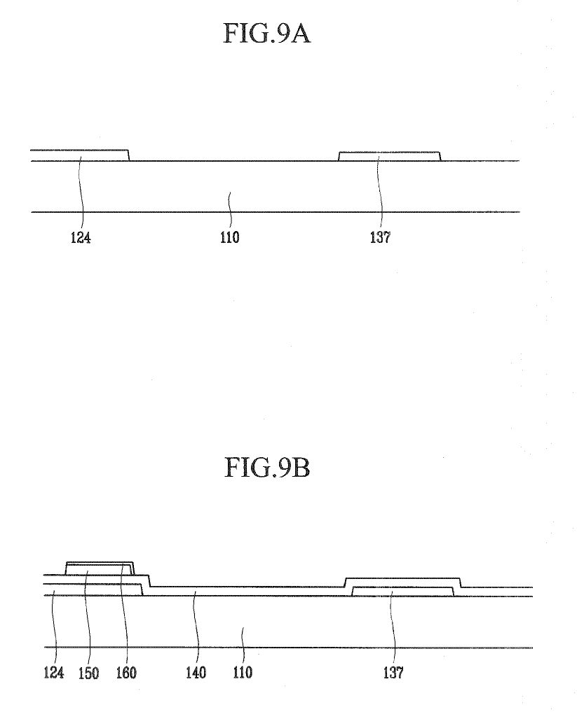

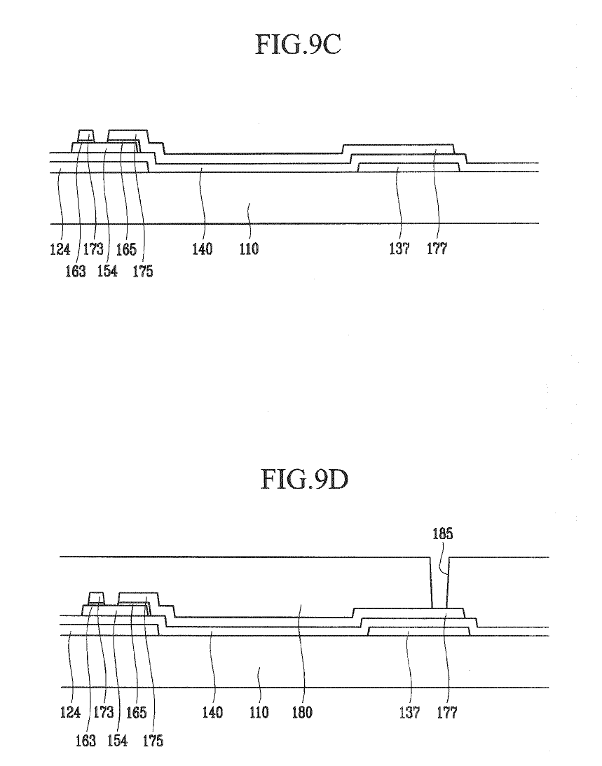

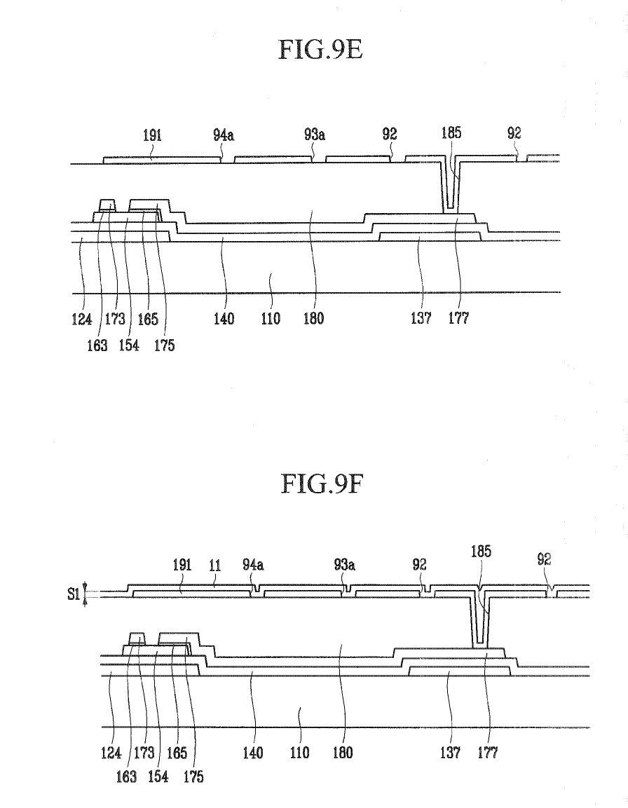

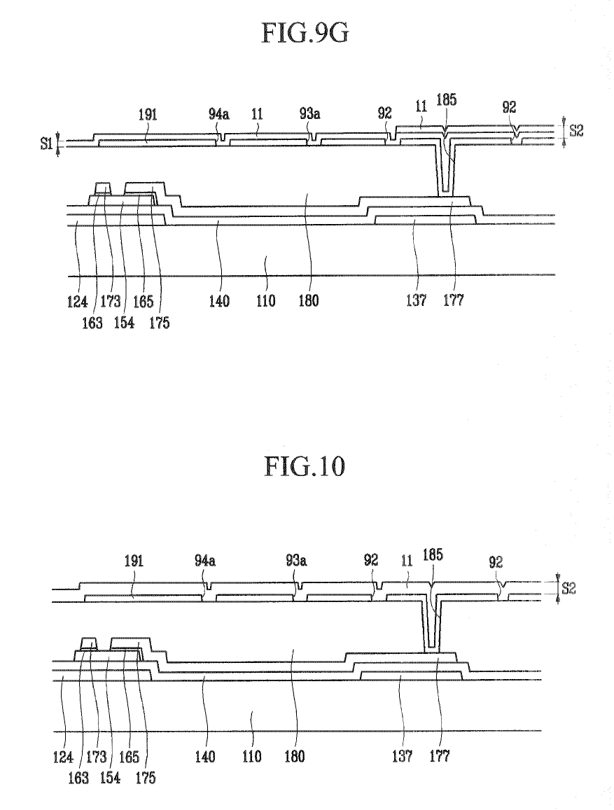

Referring to FIG. 9A to FIG. 11F, a method of manufacturing the liquid crystal panel assembly shown in FIG. 3 to FIG. 7, according to an exemplary embodiment of the present invention, is illustrated.

FIG. 9A to FIG. 9G are cross-sectional views for illustrating a method of manufacturing the thin film transistor array panel shown in FIGS. 3, 4, 6, and 7, according to an exemplary embodiment of the present invention.

Referring to FIG. 9A, metal layers are sequentially deposited on a substrate 110 by sputtering, and photolithography is performed to form a plurality of gate lines 121 each having a gate electrode 124 and an end portion 129 and a plurality of storage electrode lines 131 each having a storage electrode 137 on the substrate 110.

Referring to FIG. 9B, a gate insulating layer 140 is deposited on the substrate 110, intrinsic amorphous silicon and an impurity amorphous silicon layer (extrinsic amorphous silicon) are sequentially deposited on the substrate 110, and the two upper layers are patterned to form a plurality of impurity semiconductor islands 160 and semiconductor islands 150.

Referring to FIG. 9C, after the metal layers are deposited on the substrate 110 by sputtering, photolithography is performed to form a plurality of data lines 171 each having a source electrode 173 and an end portion 179, and a plurality of drain electrodes 175.

Then, an exposed portion of the impurity semiconductor, which is not covered by the data line 171 and the drain electrode 175, is removed to form ohmic contact island members 163 and 165, while exposing a portion of the intrinsic semiconductor 154 disposed under the exposed portion. An oxygen plasma process may be performed to cause the surface of the exposed portion of the intrinsic semiconductor 154 stable.

Referring to FIG. 9D, an inorganic insulator is deposited by chemical vapor deposition or a photosensitive organic insulating material is deposited to form a passivation layer 180. The passivation layer 180 and the gate insulating layer 140 are etched to form contact holes 184, 182, and 185.

Referring to FIG. 9E, an ITO or IZO layer is deposited by sputtering, and photolithography is performed to form a plurality of pixel electrodes 191 and a plurality of contact assisting members 81 and 82. Then, a mask (not shown) is arranged, and exposure and development are performed to form cutouts 92, 94a, and 94b. A plurality of contact assisting members 81 and 82 are formed.

Referring to FIG. 9F, an alignment layer 11 having a first thickness (s1) is formed. The first thickness (s1) can be, for example, about 500 Å. The alignment layer 11 may be an inorganic alignment layer formed from an inorganic material, such as, for example, amorphous silicon (a-Si), silicon carbide (SiC), silicon nitride (SiN), silicon oxide (SiOx), or fluorinated diamond-like carbon. The alignment layer 11 may be deposited by chemical vapor deposition (CVD).

Referring to FIG. 9G, an alignment layer 11 having a second thickness is formed on a certain region by using a metal mask. The second thickness can be, for example, about 500 Å.

Thus, the first region A has an alignment layer 11 having a thickness (s2) of about 1000 Å, and the second region B has an alignment layer having a thickness (s1) of about 500 Å, thereby forming an alignment layer 11 having different thicknesses.

Referring to FIG. 10, a method of manufacturing the liquid crystal panel assembly 300, shown in FIG. 3 to FIG. 7, according to an exemplary embodiment of the present invention is illustrated.

FIG. 10 is a cross-sectional view for illustrating a method of manufacturing a thin film transistor array panel 100 shown in FIG. 3, FIG. 4, FIG. 6, and FIG. 7, according to an exemplary embodiment of the present invention.

As described with respect to FIG. 9A to FIG. 9E, the gate line 121, the storage electrode line 131, the gate insulating layer 140, the semiconductor island 154, the ohmic contact members 163 and 165, the data line 171, the drain electrode 175, the passivation layer 180, and the pixel electrode 191 are formed on the substrate 110.

Referring to FIG. 10, the alignment layer 11 having a third thickness (s2) of about 1000 Å, for example, is formed. At least one region such as region B of the alignment layer 11 is etched by a laser. The etched thickness (s1) can be, for example, about 500 Å. Thus, the alignment layer 11 in the region A has a thickness of about 1000 Å, and the alignment layer 11 in the region B has a thickness of about 500 Å, thereby forming two regions having the alignment layer 11 of different thicknesses.

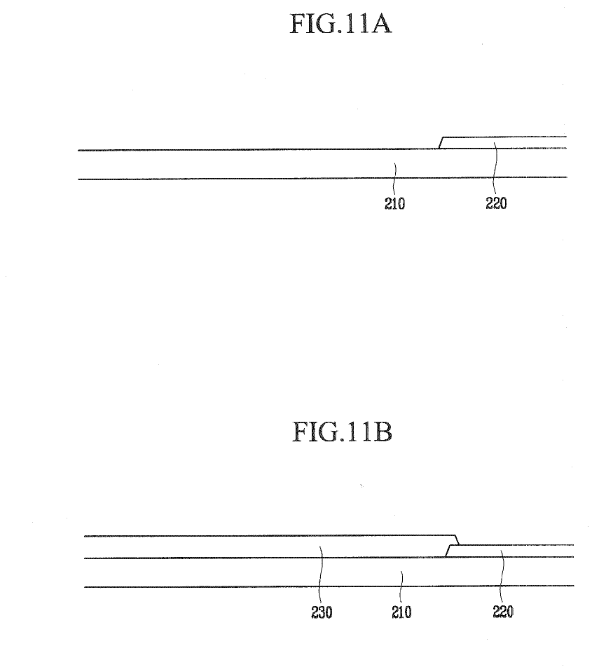

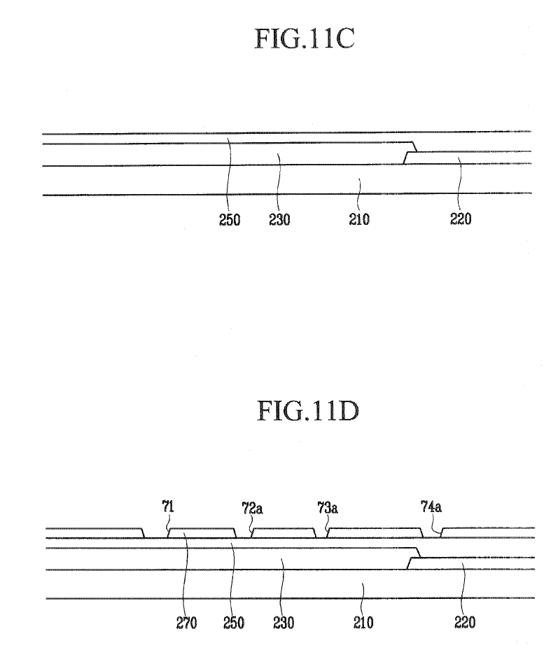

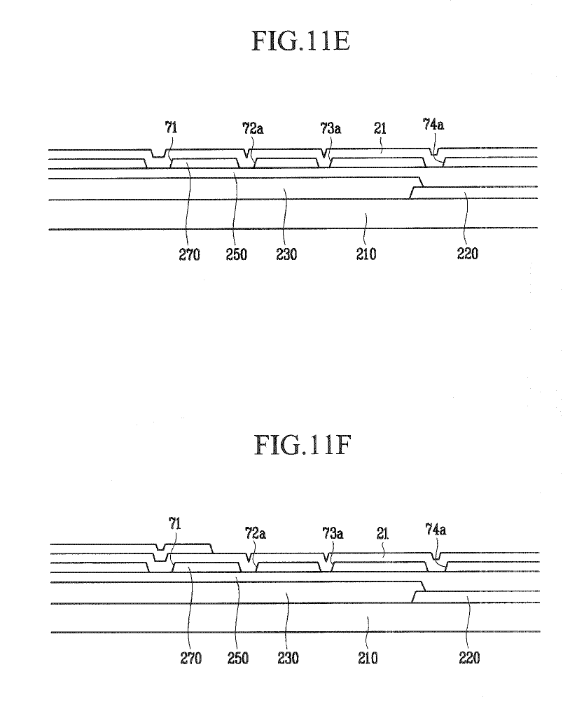

Referring to FIG. 11A to FIG. 11F, a method of manufacturing the common electrode panel 200 shown in FIG. 3, FIG. 5, and FIG. 6 is illustrated.

FIG. 11A to FIG. 11F are cross-sectional views for illustrating a method of manufacturing the common electrode panel shown in FIG. 3, FIG. 5, and FIG. 6, according to an exemplary embodiment of the present invention, respectively.

Referring to FIG. 11A, chrominum is deposited on a substrate 210 and patterned to form a light blocking member 220.

Referring to FIG. 11B, a photosensitive resin having a pigment is deposited by spin coating. The photosensitive resin is exposed and developed, and a hard bake is performed to form a plurality of color filters 230. The pigment may be one of red, green, and blue, and the processing shown in FIG. 11B is repeated for each color.

Referring to FIG. 11C, an organic material is deposited to form an overcoat 250. ITO or IZO is then deposited by sputtering to form a common electrode 270.

Referring to FIG. 11D, a positive photosensitive film (not shown) is deposited and a mask (not shown) is arranged thereon, and the mask exposed and developed to form cutouts 71-74b.

Referring to FIG. 11E, an alignment layer 21 having a first thickness is formed. The first thickness can be, for example, about 500 Å. The alignment layer 21 may be an inorganic alignment layer comprising an inorganic material, such as amorphous silicon (a-Si), silicon carbide (SiC), silicon nitride (SiN), silicon oxide (SiOx), or fluorinated diamond-like carbon. The alignment layer 21 may be deposited by chemical vapor deposition (CVD).

Referring to FIG. 11F, an alignment layer 21 having a second thickness is formed on a certain region by using a metal mask. The second thickness can be, for example, about 500 Å.

Thus, the alignment layer 21 in the first region A has a thickness of about 1000 Å, and the alignment layer 21 in the second region B has a thickness of about 500 Å, thereby forming the alignment layer 21 having different thicknesses. When the alignment layer 21 is an inorganic alignment layer, it is easier to form a plurality of regions having different thicknesses.

In an exemplary embodiment, an alignment layer may be formed by depositing an inorganic alignment layer having a predetermined thickness. For example, the inorganic alignment layer 11 can be formed on the thin film transistor array panel 100 as shown in FIG. 10, and etching a certain portion of the inorganic alignment layer with a different thickness. As a result, an inorganic alignment layer having different thicknesses may be formed.

According to an exemplary embodiment of the present invention, two regions at which an alignment layer has different thicknesses are formed, and thus a voltage for each region is differently controlled and side visibilty is improved without reducing an aperture ratio.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A liquid crystal display comprising:
a pixel having a first region and a second region, wherein the pixel comprises:
a pixel electrode;
a common electrode facing the pixel electrode; and
an alignment layer formed on at least one of the pixel electrode and the common electrode,
wherein the alignment layer has different thicknesses in a first region and a second region, and a voltage ratio of the second region to the first region is about 0.1 to 0.95.

2. The liquid crystal display of claim 1, wherein the voltage ratio of the second region to the first region is about 0.5 to 0.9.

3. The liquid crystal display of claim 1, wherein a thickness ratio of the alignment layer in the second region to the alignment layer in the first region is about 0.1 to 0.95.

4. The liquid crystal display of claim 1, wherein the alignment layer comprises an inorganic alignment layer.

5. The liquid crystal display of claim 4, wherein the inorganic alignment layer comprises at least one of amorphous silicon, silicon carbide, silicon nitride, silicon oxide, or fluorinated diamond-like carbon.

6. The liquid crystal display of claim 1, wherein an area ratio of the first region to the second region is about 1:1 to about 1:3.

7. The liquid crystal display of claim 1, further comprising a first incline determination member formed on the pixel electrode.

8. The liquid crystal display of claim 1, further comprising a second incline determination member formed on the common electrode.

9. The liquid crystal display of claim 8, wherein the first and second incline determination members have a cutout having a slanting portion.

10. A liquid crystal display comprising:
a pixel having a first region and a second region,
wherein the pixel comprises
a pixel electrode;
a common electrode facing the pixel electrode; and
an inorganic alignment layer formed on at least one of the pixel electrode and the common electrode,
wherein the inorganic alignment layer has different thicknesses in a firs region and a second region.

11. The liquid crystal display of claim 10, wherein a thickness ratio of the inorganic alignment layer in the first region to the inorganic alignment layer in the second region is about b 0.1 to 0.95.

12. A method for manufacturing a liquid crystal display, the method comprising:
forming a gate line having a gate electrode on a first substrate;
depositing a gate insulating layer on the first substrate;
forming a semiconductor on the gate insulating layer;
forming a data line and a drain electrode on the semiconductor and the gate insulating layer;
forming a pixel electrode connected to the drain electrode; and
forming an inorganic alignment layer having first and second portions on the pixel electrode, the first and second portions having different thicknesses from each other.

13. The method of claim 12, further comprising:
forming a light blocking member on a second substrate;
forming a color filter on the second substrate;
forming a common electrode on the light blocking member and the color filter; and
forming an inorganic alignment layer having first and second portions having different thicknesses from each other on the common electrode.

14. The method of claim 12, wherein a thickness ratio of the second portion to the first portion is about 0.1 to 0.95.

15. The method of claim 13, wherein a thickness ratio of the second portion to the first portion is about 0.1 to 0.95.

16. The method of claim 12, wherein forming the inorganic alignment layer comprises depositing an inorganic material by chemical vapor deposition.

17. The method of claim 12, wherein forming the inorganic alignment layer comprises:
depositing an inorganic material having a first thickness on the entire pixel electrode; and
depositing the inorganic material having a second thickness on at least one portion of the pixel electrode.

18. The method of claim 17, wherein a ratio of a sum of the first and second thicknesses to the first thickness is about 0.1 to 0.95.

19. The method of claim 12, wherein forming the inorganic alignment layer comprises:
depositing an inorganic material having a first thickness on the entire pixel electrode; and
etching a portion having a second thickness from the deposited inorganic material having the first thickness.

20. The method of claim 19, wherein a ratio of a difference between the first and second thicknesses to the first thickness is about 0.1 to 0.95.

21. The method of claim 19, wherein the etching is performed using a laser.

22. The method of claim 12, wherein the inorganic alignment layer comprises at least one of amorphous silicon, silicon carbide, silicon nitride, silicon oxide, or fluorinated diamond-like carbon.

23. The method of claim 12, wherein an area ratio of the first portion to the second portion is about 1:1 to about 1:3.
